(19) United States
(12) Patent Application Publication
(10) Pub. No.: US 2010/0034412 A1
(43) Pub. Date: Feb. 11, 2010

(54) LIP SHIELD FOR MICROPHONES

(76) Inventor: Zygmund E. Parda, Epping, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 12/188,728

(22) Filed: Aug. 8, 2008

(51) Int. Cl. H04R 11/04

(52) U.S. Cl. 381/355

(57) ABSTRACT

A lip shield or block is attachable to a microphone and is sized to block or shield the lips of the user from being viewed by third parties when the user is speaking into the microphone.

### TECHNICAL FIELD

The present invention relates to microphones and other devices which are designed to receive speech from the mouth of the user and more particularly, relates to a shield which prevents third parties from reading the lips of a user speaking into a microphone thereby understanding what the user is saying.

### BACKGROUND INFORMATION

Microphones, headsets and the like are used extensively today to allow user to communicate remotely with another user. One example of such use is in the sports arena wherein football coaches, for example, communicate information relative to the plays to be run by the team in near real-time format.

The problem with this type of communication is that if intercepted, third parties can make extensive use of this information. This was recently highlighted in the context of the National Football League wherein a person speaking play information into a microphone was recorded and his lips later read to de-code or understand this play information. This play information then became useful to an opposing team. The same or similar situation exists with regard to almost any setting wherein a third party does not have to intercept the actual voice communication but rather, can utilize the speaker's lip pattern to decode or otherwise understand what is being spoken. This information, particularly if confidential, may be very useful to an opponent or of the third-party and may be very damaging to the party who is speaking.

Accordingly, what is needed is a universal system which can easily be added to a microphone and that can shield the lips of the speaker such that no information about what is being spoken can be gleaned from the speaker's lips.

### SUMMARY

### Brief Description of the Drawings

These and other features and advantages of the present invention will be better understood by reading the following detailed description, taken together with the drawings wherein:

FIG. 1 is a photograph of a prior art microphone and headset device;

FIG. 2 is a photograph of a microphone and headset device on which is installed a lip shield according to the present invention;

FIG. 3 is a photograph showing the lip shield of the present invention including one embodiment of a means for attaching the lip shield to a microphone; and

FIG. 4 is a photograph showing the front side of the lip shield of the present invention.

### DETAILED DESCRIPTION OF THE PREFERRED EMBODIMENTS

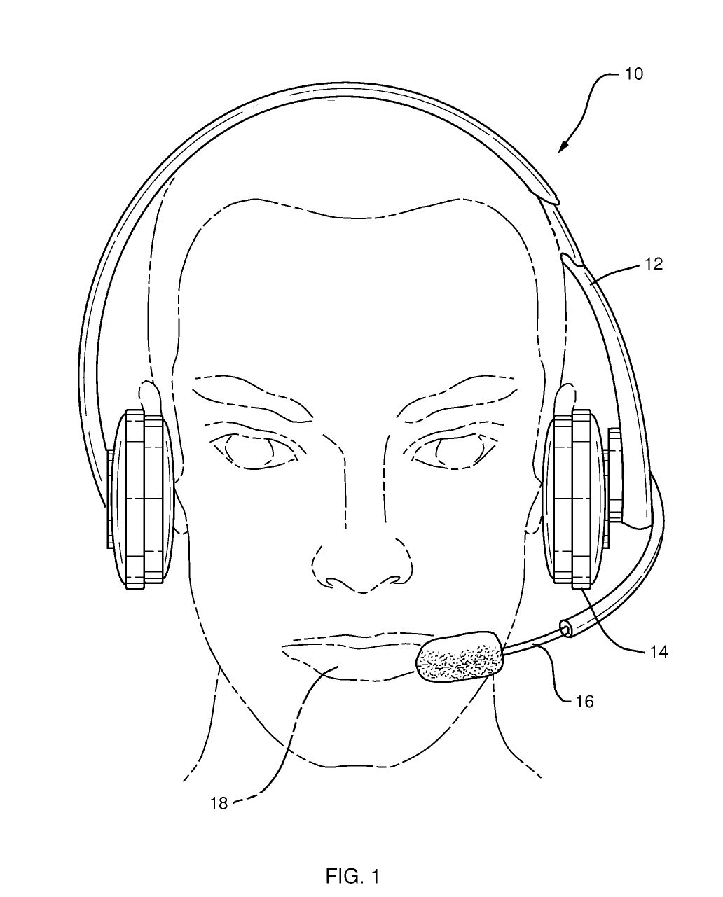

One embodiment of a typical prior art microphone is shown generally at 10, FIG. 1, and includes a headset portion 12 having a least one earpiece 14 and which is attached to a microphone 16 which is generally placed in front of the lips 18 of the user. In this manner, the user's hands are free permitting the user to view papers and the like while at the same time speaking. The problem with the prior art head set, however, is that the users lips are vulnerable to be read by a third party who might be viewing or even recording the conversation nearby or from a far. While the present invention will be explained with regard to a microphone mounted on a headset, this is not a limitation of the present invention since the present invention can be used equally well on a hand held microphone.

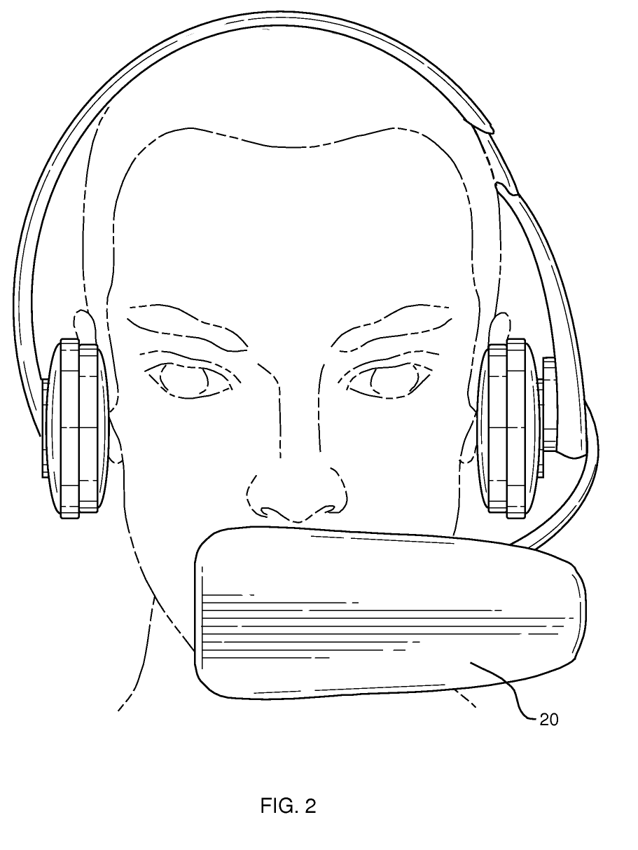

Accordingly, the present invention includes a lip shield 20, FIG. 2, which attaches to the microphone and allows the headset to otherwise be used as it previously was while at the same time blocking or shielding the lips of the user from being read by a third party. The lip shield 20 according to the present invention does not have to be of any particular shape or size but must merely be attachable by some mechanism to the microphone and be large enough to block or shield the lips of the user when in position and installed on the microphone.

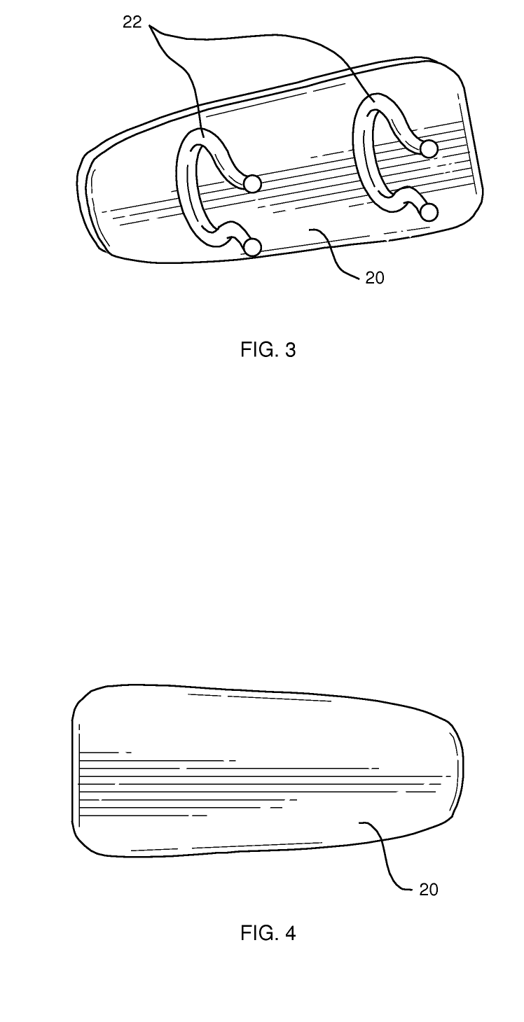

In the preferred embodiment, the lip shield 20, FIG. 3, is approximately 5 inches long, 2 inches wide at one end and 1 inch wide at the opposite end. The lip shield 20 is made out of an inexpensive plastic material. In addition, the lip shield 20 includes one or more fastening devices 22 which are used to hold the lip shield 20 in place on the microphone 16 being utilized by the user.

In this embodiment, the fastening devices 22 include resilient plastic clips glued or otherwise fastened in place to the backside of the lip shield 20 and which frictionally engage with the microphone 16 being utilized by the user. Other types of fastening devices 22 are contemplated by the present invention and are well known to those skilled in the art. In addition, lip shield 20 is the exemplary embodiment addition on having a particular shape, this is also not a limitation of the present invention as any shape and size which will allow it to be held in place on a microphone while still shielding the lips of the user is contemplated by the invention.

The present invention is not intended to be limited to a device or method which must satisfy one or more of any stated or implied objects or features of the invention and should not be limited to the preferred, exemplary, or primary embodiment(s) described herein. Modifications and substitutions by one of ordinary skill in the art are considered to be within the scope of the present invention, which is not to be limited except by the allowed claims and their legal equivalents.

The invention claimed is:

1. A lip shield for a microphone, comprising
a shielding device, configured for attachment to a microphone, said shielding device sized and shaped to generally block or shield a user's lips from being viewed by third parties when said lip shield is installed on a microphone being utilized by a user to transmit speech of the user.

2. The lip shield of claim 1, wherein said shielding device further includes at least one attachment device, for attaching said shielding device to said microphone being utilized by said user.

3. The lip shield of claim 2, wherein said at least one attachment device includes a plastic, resilient clip, coupled to said shielding device proximate one end, and configured for attachment to a microphone proximate another end.

4. The lip shield of claim 1, wherein said shielding device is made of plastic.

5. A lip shield for a microphone, comprising
a shielding device, configured for attachment to a microphone, said shielding device sized and shaped to generally block or shield a user's lips from being viewed by third parties when said lip shield is installed on a microphone being utilized by a user to transmit speech of the user, said shielding device further including at least one attachment device, for attaching said shielding device to said microphone being utilized by said user.

6. A lip shield for a microphone, comprising
a shielding device, configured for attachment to a microphone, said shielding device sized and shaped to generally block or shield a user's lips from being viewed by third parties when said lip shield is installed on a microphone being utilized by a user to transmit speech of the user, said shielding device further including at least one attachment device, for attaching said shielding device to said microphone being utilized by said user, said at least one attachment device including a plastic, resilient clip, coupled to said shielding device proximate one end, and configured for attachment to a microphone proximate another end.
